(19) United States
(12) Patent Application Publication
(10) Pub. No.: US 2022/0281151 A1
(43) Pub. Date: Sep. 8, 2022

(54) U-SHAPED EXTRUSION LINE

(71) Applicant: Felix SORKIN, Stafford, TX (US)

(72) Inventor: Felix SORKIN, Stafford, TX (US)

(21) Appl. No.: 17/688,310

(22) Filed: Mar. 7, 2022

Related U.S. Application Data
(60) Provisional application No. 63/157,410, filed on Mar. 5, 2021.

(51) Int. Cl. B29C 48/88; B29C 48/05; B29C 48/154

(52) U.S. Cl. CPC B29C 48/919; B29C 48/05; B29C 48/154; B29C 48/911

(57) ABSTRACT

A strand sheathing system may include a pay off device, an extruder system, and a cooling trough assembly. The extruder system may include an extruder head configured to receive a cable from the pay off device and deposit a sheathing material to the cable. The cooling trough assembly may include a first cooling trough and a second cooling trough. The strand sheathing system may include a guide assembly that includes a frame mechanically coupled between the first cooling trough and the second cooling trough. The guide assembly may include one or more guide elements such as rollers, ball bearings, or flat pieces of metal.

### CROSS-REFERENCE TO RELATED APPLICATIONS

The instant application claims priority to U.S. Provisional Application Number 63/157,410 filed Mar. 5, 2021 which application is incorporated herein by reference in its entirety.

### TECHNICAL FIELD/FIELD OF THE DISCLOSURE

The present disclosure relates to production of strands or other wire or cable-like materials or any article in need of a coating such as an extrusion coating or sheathing.

### BACKGROUND OF THE DISCLOSURE

Many structures are built using concrete, including, for instance, buildings, parking structures, apartments, condominiums, hotels, mixed-use buildings, casinos, hospitals, medical buildings, government buildings, research/academic institutions, industrial buildings, malls, bridges, pavement, tanks, reservoirs, silos, foundations, sports courts, and other structures.

Pre-stressed concrete is structural concrete in which internal stresses are introduced to reduce potential tensile stresses in the concrete resulting from applied loads. This can be accomplished by two methods—pre-tensioned pre-stressing and post-tensioned pre-stressing. When post-tensioning concrete, the pre-stressing assembly is tensioned after the concrete has cured to a specified strength. The pre-stressing assembly, commonly known as a tendon, may include for example and without limitation, anchorages, one or more strands, and sheaths or ducts surrounding the strand(s). A strand may be tensioned between a pair of anchors, which are embedded in the concrete. The strand may be formed from a metal or composite or any suitable material exhibiting tensile strength, including, for example and without limitation, reinforcing steel, single wire cable, or multi-wire cable. The strand is typically fixedly coupled to a fixed anchorage positioned at one end of the tendon, the so-called “fixed end”, and is adapted to be stressed at the other anchor, the “stressing end” of the tendon. The strand is generally retained in each anchor by one or more wedges that engage a tapered recess in the anchor body so that when the strand is placed under tension, the wedges engage the strand more tightly.

One end of the strand extends through the stressing end anchor and out of the concrete body in which the anchor is embedded. In some cases, a pocket former is placed around the strand before the concrete is poured, which results in a pocket in the cured concrete. In these cases, the end of the strand extends through and outwardly from the pocket. Once the concrete has cured, a tensile force can be applied to the extending strand end, causing an elongation of the strand. Releasing the tensile force causes the strand to be more tightly gripped by the wedges, thereby maintaining its elongated stress, which is transferred to the concrete via the anchors. The portion of the strand that extends out of the stressing anchor is typically removed.

### SUMMARY

The present disclosure provides for a strand sheathing system. The strand sheathing system includes a pay off device. The strand sheathing system includes an extruder system. The extruder system includes an extruder head configured to receive a cable from the pay off device and deposit a sheathing material to the cable. The strand sheathing system includes a cooling trough assembly that includes a first cooling trough and a second cooling trough.

The present disclosure also provides for a cooling trough assembly. The cooling trough assembly includes a first cooling trough, a second cooling trough, and a guide assembly. The guide assembly includes a frame mechanically coupled between the first cooling trough and the second cooling trough.

The present disclosure also provides for a method. The method may include positioning a cable on a pay off device, passing the cable through an extruder head of an extruder system, and depositing a sheathing material about the cable as the cable passes through the extruder head to form a strand. The method may include passing the strand through a first cooling trough, redirecting the strand to enter a second cooling trough, and passing the strand through the second cooling trough.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts an overhead view of a strand sheathing system consistent with at least one embodiment of the present disclosure.

FIG. 1A depicts a detail view of the strand sheathing system of FIG. 1.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

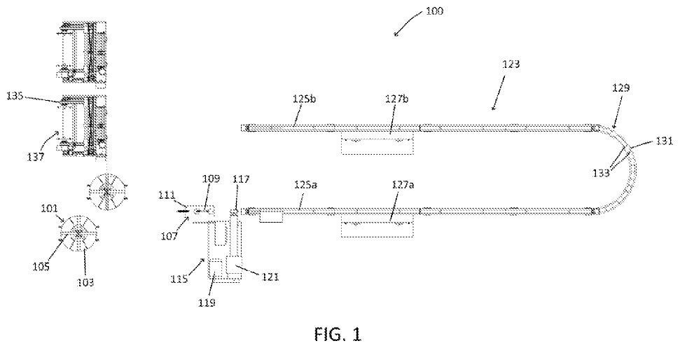

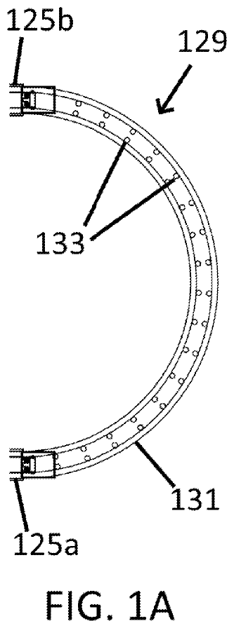

FIG. 1 depicts strand sheathing system 100. Strand sheathing system 100 may be part of a mill and may be used to extrude, apply grease and sheathing to, and coil a strand as discussed below. The strand may be used, for example and without limitation, in pre-stressed concrete, rock anchors, ground anchors, and soil anchors. Strand sheathing system 100 may include pay off device 101. Pay off device 101 may receive a spool of cable used to form the strand. In some embodiments, pay off device 101 may be a lazy susan. The cable may, in some embodiments, be a single or multi-strand cable. In some embodiments, pay off device 101 may include turntable 103 and may include retaining arms 105. Pay off device 101 may be driven or not driven. When driven, pay off device 101 may include a driving mechanism such as a motor to turn pay off device 101 and thereby unspool the cable for use in strand sheathing system 100. When not driven, pay off device 101 may turn and unspool the cable as the cable is pulled by other components of strand sheathing system 100.

In some embodiments, strand sheathing system 100 may include greasing system 107. Greasing system 107 may include grease applicator 109. Greasing system 107 may be positioned to receive the cable as it is pulled from pay off device 101 in grease applicator 109. Greasing system 107 may include one or more pumps 111 used to draw grease from one or more grease tanks such that the grease is transmitted to grease applicator 109. Grease applicator 109 may be tubular and include one or more nozzles positioned on an inner surface thereof such that grease is applied to the cable as the cable passes through grease applicator 109.

In some embodiments, strand sheathing system 100 may include extruder system 115. Extruder system 115 may include extruder head 117. Extruder system 115 may be positioned to receive the cable in extruder head 117 as it exits grease applicator 109. Extruder system 115 may include storage hopper 119 and pump 121. Pump 121 may provide sheathing material from storage hopper 119 to extruder head 117. Extruder head 117 may be tubular and may include one or more nozzles on an inner surface thereof such that sheathing material is deposited about and molded to the exterior of the cable. In some embodiments, extruder head 117 may create a generally cylindrical outer profile for the sheathing material.

In some embodiments, components of extruder system 115 may be heated such that the sheathing material is melted as it enters and exits extruder head 117. Sheathing material may be a thermoplastic or thermoset material.

In some embodiments, once the cable exits extruder head 117 having the sheathing material molded thereto, the cable may define a strand. In some embodiments, once exiting extruder head 117, the strand may enter cooling trough assembly 123. Cooling trough assembly 123 may include one or more cooling troughs 125a, 125b and water tanks 127a, 127b such that cooling troughs 125a, 125b are at least partially filled with water or other fluid. Cooling trough assembly 123 may be formed such that the strand is substantially submerged in the water within cooling troughs 125a, 125b. In some embodiments, without being bound to theory, water within cooling trough assembly 123 may cool the sheathing material of the strand as the strand passes through cooling trough assembly 123.

In some embodiments, cooling trough assembly 123 may be U-shaped. In such an embodiment, first cooling trough 125a may be coupled to second cooling trough 125b by guide assembly 129. Guide assembly 129, as shown in FIG. 1A, may include frame 131. Frame 131 may be mechanically coupled between first cooling trough 125a and second cooling trough 125b. Frame 131 may be positioned to redirect the strand as the strand exits first cooling trough 125a such that the strand enters second cooling trough 125b. In some embodiments, guide assembly 129 may include one or more guide elements 133 positioned on frame 131 that may be used to help redirect the strand through frame 131. In some embodiments, guide elements 133 may include one or more of rollers, ball bearings, or flat pieces of metal. Although depicted as extending through a 180° path, one of ordinary skill in the art with the benefit of this disclosure will understand that first cooling trough 125a and second cooling trough 125b may be positioned in any orientation.

Although only two cooling troughs 125a, 125b and a single guide assembly 129 are shown and discussed, one of ordinary skill in the art with the benefit of this disclosure will understand that additional cooling troughs and roller assemblies may be used by adding additional roller assemblies to link the additional cooling troughs.

In some embodiments, strand sheathing system 100 may include winding machine 135. Winding machine 135 may be positioned to receive the strand as the strand exits second cooling trough 125b (or the final cooling trough when more than two cooling troughs are included within strand sheathing system 100). Winding machine 135 may, in some embodiments, be driven such that winding machine 135 pulls the strand and cable through strand sheathing system 100. Winding machine 135 may wind the strand onto spool 137 by rotating the spool. Once on spool 137, the strand may be transported by removing spool 137 from winding machine 135.

The foregoing has been described with respect to extrusion employed in a strand sheathing system for making strands used in tensioning of concrete. However, it should be understood that the extrusion systems and methods described herein may be much more widely applicable. For example, the extrusion techniques and system may be applicable to nearly any type of strand, wire, or cable in need of at least one extruded coating. Of course, the techniques and systems may also be suitable making dual layer, three layer, or more wires, cables, ropes, and the like. Of course, the extruded coating may also have two or more colors if desired for a given application.

The type of sheathing material used herein is not particularly limited and may be any type of thermoplastic or thermoset material. Typical sheathing material may vary depending upon the wire or cable being coated and the desired application. Representative materials may include polyethylenes, polypropylenes, polyvinyl chlorides, nylons, acrylic resins, polyesters, vinyl esters esters, epoxy resins, and polyurethanes, and mixtures thereof.

In another embodiment, the application pertains to an extrusion system comprising: an extruder head configured to receive an article to be coated and deposit a sheathing material on the article; a first cooling trough; a second cooling trough; and a guide assembly. The guide assembly is operably linked to the first cooling trough and the second cooling trough. The first cooling trough, the second cooling trough, and the guide assembly may be assembled in a U shape with the guide assembly between the first cooling trough and the second cooling trough. The guide assembly redirects the article from the first cooling trough to the second cooling trough. A conveyor or other convenient mechanism may be employed to move the article to the extruder head and then to the first and the second cooling trough.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A strand sheathing system comprising:
a pay off device;
an extruder system, the extruder system including an extruder head, the extruder head configured to receive a cable from the pay off device and deposit a sheathing material to the cable;
a cooling trough assembly, the cooling trough assembly including:
a first cooling trough; and
a second cooling trough.

2. The strand sheathing system of claim 1, further comprising a guide assembly, the guide assembly including a frame, the frame mechanically coupled between the first cooling trough and the second cooling trough.

3. The strand sheathing system of claim 2, wherein the guide assembly further comprises one or more guide elements, the guide elements positioned to guide a strand from the first cooling trough to the second cooling trough.

4. The strand sheathing system of claim 3, wherein the guide elements comprise one or more of rollers, ball bearings, and flat pieces of metal.

5. The strand sheathing system of claim 1, further comprising a first water tank coupled to the first cooling trough.

6. The strand sheathing system of claim 1, further comprising a greasing system, the greasing system including a grease applicator, the grease applicator being tubular and positioned to receive the cable between the pay off device and the extruder head, the grease applicator positioned to apply grease to the cable.

7. The strand sheathing system of claim 1, further comprising a winding machine, the winding machine configured to rotate a spool such that a strand exiting the second cooling trough is wound about the spool.

8. A cooling trough assembly, the cooling trough assembly including:
a first cooling trough;
a second cooling trough; and
a guide assembly, the guide assembly including a frame, the frame mechanically coupled between the first cooling trough and the second cooling trough.

9. The cooling trough assembly of claim 8, wherein the guide assembly further comprises one or more guide elements, the guide elements positioned to guide a strand from the first cooling trough to the second cooling trough.

10. The cooling trough assembly of claim 9, wherein the guide elements comprise one or more of rollers, ball bearings, and flat pieces of metal.

11. The cooling trough assembly of claim 8, further comprising a first water tank coupled to the first cooling trough.

12. A method comprising:
positioning a cable on a pay off device;
passing the cable through an extruder head of an extruder system;
depositing a sheathing material about the cable as the cable passes through the extruder head to form a strand;
passing the strand through a first cooling trough;
redirecting the strand to enter a second cooling trough; and
passing the strand through the second cooling trough.

13. The method of claim 12, further comprising passing the cable through a greasing system before the cable enters the extrusion head and applying grease to the cable with the greasing system.

14. The method of claim 12, further comprising winding the strand onto a spool with a winding machine.

15. The method of claim 12, wherein redirecting the strand to enter a second cooling trough comprises passing the strand through a guide assembly.

16. The method of claim 15, wherein the guide assembly comprises one or more guide elements.

17. The method of claim 16, wherein the guide elements comprise one or more of rollers, ball bearings, and flat pieces of metal.

18. An extrusion system comprising:
an extruder head configured to receive an article to be coated and deposit a sheathing material on the article;
a first cooling trough;
a second cooling trough; and
a guide assembly operably linked to the first cooling trough and the second cooling trough;
wherein the first cooling trough, the second cooling trough, and the guide assembly are assembled in a U shape with the guide assembly between the first cooling trough and the second cooling trough and wherein the guide assembly redirects the article from the first cooling trough to the second cooling trough.
